(19) United States
(12) Patent Application Publication
(10) Pub. No.: US 2001/0015507 A1
(43) Pub. Date: Aug. 23, 2001

(54) Porous partition with photocatalyst

(76) Inventors: Jeffrey H. Sherman, The Woodlands, TX (US); Philip Grosso, Auburn, CA (US)

Correspondence Address: Michael A. O'Neil, Michael A. O'Neil, P.C., Suite 1030, 5949 Sherry Lane, Dallas, TX, 75225, US

(21) Appl. No.: 09/752,908

(22) Filed: Dec. 28, 2000

Related U.S. Application Data
(63) Continuation-in-part of application No. 09/522,982, filed on Mar. 10, 2000.
Application No. 09/522,982 is a continuation-in-part of application No. 09/370,945, filed on Aug. 9, 1999, now Pat. No. 6,156,279.
Application No. 09/370,945 is a division of application No. 09/224,394, filed on Dec. 31, 1998, now Pat. No. 6,129,818.
Application No. 09/224,394 is a continuation-in-part of application No. 09/058,494, filed on Apr. 10, 1998, now Pat. No. 5,954,925.

(51) Int. Cl. B29C 35/02; B29C 67/20

(52) U.S. Cl. 264/42; 264/122

(57) ABSTRACT

In one embodiment a porous partition having predetermined porosity and predetermined photocatalytic properties is formed by mixing particles of photocatalytic material with particles of structural material, forming the particle mixture into a predetermined shape, applying pressure to the formed particle mixture, and heating the formed particle mixture to a predetermined temperature in a predetermined atmosphere. In another embodiment, the particles of structural material and the particles of photocatalytic material are separately formed, pressurized and heated, after which the sintered photocatalytic article is joined to the sintered structural article. In yet another embodiment a sol-gel comprising a metal oxide semiconductor and an organic component is drawn into the pores of a porous stainless steel layer and is thereafter heated to oxidize the organic component leaving the semiconductor in the pores of the stainless steel.

### TECHNICAL FIELD

This invention relates generally to the manufacture of methanol from methane, and more particularly to porous partition/photocatalytic structures which are useful in methods of and apparatus for manufacturing methanol from methane.

### BACKGROUND AND SUMMARY OF THE INVENTION

Methanol, the simplest of the alcohols, is a highly desirable substance which is useful as a fuel, as a solvent, and as a feedstock in the manufacture of more complex hydrocarbons. In accordance with the method of methanol manufacture that is currently practiced in the petroleum industry, methane is first converted to synthesis gas, a mixture of carbon monoxide and hydrogen. The synthesis gas is then converted over an alumina-based catalyst to methanol. The formation of synthesis gas from methane is an expensive process.

As will be apparent, methane and methanol are closely related chemically. Methane comprises a major component of natural gas and is therefore readily available. Despite the advantages inherent in producing methanol directly from methane, no commercially viable system for doing so has heretofore been developed.

The invention disclosed and claimed in parent application Ser. No. 09/522,982, filed Mar. 10, 2000, comprises a method of and apparatus for manufacturing methanol from methane. In one aspect, the method involves a semipermeable partition upon which a light-activated catalyst capable of producing hydroxyl radicals from water is deposited. Water is passed over the catalyst side of the porous surface and methane at a positive pressure is present on the opposite side of the surface. The catalyst is exposed to light while water is passed over the catalyst. The light-exposed catalyst reacts with the water molecules to form hydroxyl radicals. Methane is forced through the semipermeable partition forming small bubbles in the flowing water. The hydroxyl radicals in the water then react with the methane in the water to form methanol.

In accordance with the broader aspects of the prior invention there is generated a stream of sub-micron sized methane bubbles. Due to their extremely small size, the methane bubbles have an extremely large surface area which increases reaction efficiency. Smaller pores in the semipermeable partition facilitate the formation of smaller bubbles. Additionally, high relative velocity between the water and the catalytic surface aids in shearing the bubbles off the surface while they are still small.

In one embodiment of the prior invention, a porous tube has an exterior coating comprising a semiconductor catalyst. The porous tube is positioned within a radiation transparent tube and water is caused to continuously flow through the annular space between the two tubes. Methane is directed into the interior of the porous tube and is maintained at a pressure high enough to cause methane to pass into the water and prevent the flow of water into the interior of the tube. As the water passes over the porous tube, methane bubbles are continually sheared off of the sintered surface. The methane bubbles thus generated are sub-micron in size and then therefore present an extremely large surface area.

Electromagnetic radiation generated from a suitable source is directed through the radiation transparent tube and engages the semiconductor catalyst to generate hydroxyl radicals in the flowing water. The hydroxyl radicals undergo a free-radical reaction with the methane forming methanol, among other free-radical reaction products. Subsequently, the methanol is separated from the reaction mixture by distillation.

In another embodiment of the prior invention, a porous tube surrounds a tubular lamp. The inside diameter of the tube is larger than the outside diameter of the tubular lamp thereby providing an annulus between the tube and the lamp. Methane is directed inwardly through the porous tube and is thereby formed into submicron size bubbles and sheared by high relative velocity between the inside surface of the porous tube and water flowing in the annulus between the porous tube and the lamp. A photocatalytic layer may be placed on the interior surface of the porous tube for activation by light from the lamp.

The present invention comprises semi-permeable partition/photocatalytic constructions which are particularly adapted for use in conjunction with the method and apparatus of the prior invention. Intrinsic semiconductors are characterized by a full valence band of electrons and an empty or almost empty conduction band. The conduction band is higher in energy than the valence band. Unlike metals, semiconductors have a gap between the valence and the conduction bands, known as the band gap (DEg). Electrons may not reside in the band gap unless impurity atoms or other defects are present which have energy states within the energy levels that define DE_{g}. This latter condition, that is, the incorporation of impurity atoms, can be used to create semiconductors, called extrinsic semiconductors, from large band gap materials.

In an intrinsic semiconductor, a valence band electron may be excited and “jump” from the valence band to the conduction band. To accomplish this jump, the semiconductor must adsorb enough energy to overcome the energy difference(DE_{g}) between the valence band and the conduction band. Once the jump is accomplished, the valence band has a “hole” resulting from the moved electron, while the conduction band has an extra electron. The hole in the valence band and the electron in the conduction band are now separated by a difference in electrical potential. This electrical potential has the ability to perform work in the thermodynamic sense, through either a chemical reaction or the production of electricity. In order to function in a chemical reaction, the hole or the electron or both, must separately migrate to the surface of the semiconductor where the hole or the electron can contact the chemical substrate to be oxidized (an interaction with the hole) or reduced (an interaction with the electron).

One of the factors that limits the effectiveness of semiconductors as photocatalysts or photovoltaic materials is the tendency of electrons and holes to recombine before either a chemical reaction or the generation of electricity can occur. That is, the electron in the conduction band drops back to the valence band with the release of energy, most often in a non-usable form. Thus, much research has been devoted to attempts to isolate the hole from the electron to reduce or eliminate recombination. While the probability of recombination has been reduced, the goal of eliminating recombination has not been realized.

One means of reducing hole/electron recombination is to trap the hole, the electron or both before recombination can occur. Trapping may include removing the conduction band electron by applying a bias voltage across the semiconductor, thus draining the conduction band electron to an anode away from the semiconductor through a conductive medium and ensuring that an oxidation and/or reduction reaction occurs before recombination can occur.

All of the techniques for reducing recombination can be enhanced by maximizing the surface area of the semiconductor. The more surface area the semiconductor possesses, the less distance an electron or hole must travel to be trapped.

In accordance with one embodiment of the invention, particles comprising a selected photocatalytic material are mixed with particles comprising a structural material. The photocatalytic material is preferably a semi-conductor photocatalytic material which may be titanium-based, tungsten-based, etc. The structural material may comprise stainless steel, other metals, ceramics, glass, or combinations thereof. The mixture of particles comprising photocatalytic material and particles comprising structural material is initially molded into a desired shape and is thereafter subjected to hydrostatic pressure. The application of hydrostatic pressure to the molded configuration determines the final shape of the article and provides sufficient structural rigidity to facilitate further handling. The molded article is then fired at a predetermined temperature in a predetermined atmosphere which completes the sintering operation. The result is a sintered article having predetermined porosity characteristics and predetermined photocatalytic characteristics.

In accordance with a second embodiment of the invention, a porous partition is formed by molding particles comprising a selected structural material into a predetermined shape, subjecting the molded article to hydrostatic pressure, and thereafter heating the molded article to a predetermined temperature in a predetermined atmosphere. Particles comprising a photocatalytic material are molded into a configuration which complements the configuration of the porous partition. The molded photocatalytic article is then subjected to hydrostatic pressure and is thereafter heated to a predetermined temperature in a predetermined atmosphere. The resulting sintered photocatalytic article is joined to the sintered porous partition to provide a porous partition having a photocatalytic layer on one surface thereof.

In accordance with a third embodiment of the invention, a porous stainless steel layer has a predetermined nominal pore size. A surface of the stainless steel layer is contacted with a semiconductor oxide in a sol-gel matrix. The sol-gel matrix is a combination of the metal oxide semiconductor, usually in an alkoxide form, and an organic component. The organic component serves as a template for assembly of the semiconductor oxide. The sol-gel may be drawn into the pores by applying vacuum to the other side of the porous steel. Likewise, capillary action may also draw the sol gel into the pores in the steel.

Once the sol-gel is applied, the porous stainless steel/sol-gel assembly is placed into an oven and the organic material in the sol-gel is completely oxidized leaving a porous semiconductor matrix in the pores of the stainless steel. By selecting the organic portion of the sol-gel, the eventual pore size of the semiconductor oxide can be controlled to a large and regular extent. If both the pore size and wall thickness of the pores are made small enough (10 to 20 nanometers), the hole in the valence band can rapidly if not immediately reach the surface of the semiconductor to participate in an oxidation reaction. Meanwhile, the electrons migrate in the opposite direction from the holes as a result of an applied electric field by moving through the porous steel, a relatively high conductor, and drain to an anode to participate in a reduction, thus completing the oxidation/reduction couple. In this way, a small bias voltage applied to the porous stainless steel enhances the removal efficiency of the conduction band electron.

### BRIEF DESCRIPTION OF THE DRAWINGS

A more complete understanding of the invention may be had by reference to the following Detailed Description when taken in conjunction with the accompanying Drawings wherein:

FIG. 1 is a diagrammatic illustration of a first method of and apparatus for manufacturing methanol from methane;

FIG. 2 is a diagrammatic illustration of a second method of and apparatus for manufacturing methanol from methane;

FIG. 3 is a sectional view comprising a diagrammatic illustration of a first embodiment of the present invention;

FIG. 4 is a sectional view comprising a diagrammatic illustration of a second embodiment of the present invention;

FIG. 5 is a flow chart further illustrating the first embodiment of the present invention;

FIG. 6 is a flow chart further illustrating the second embodiment of the present invention; and

FIG. 7 is a flow chart illustrating a third embodiment of the present invention.

### DETAILED DESCRIPTION

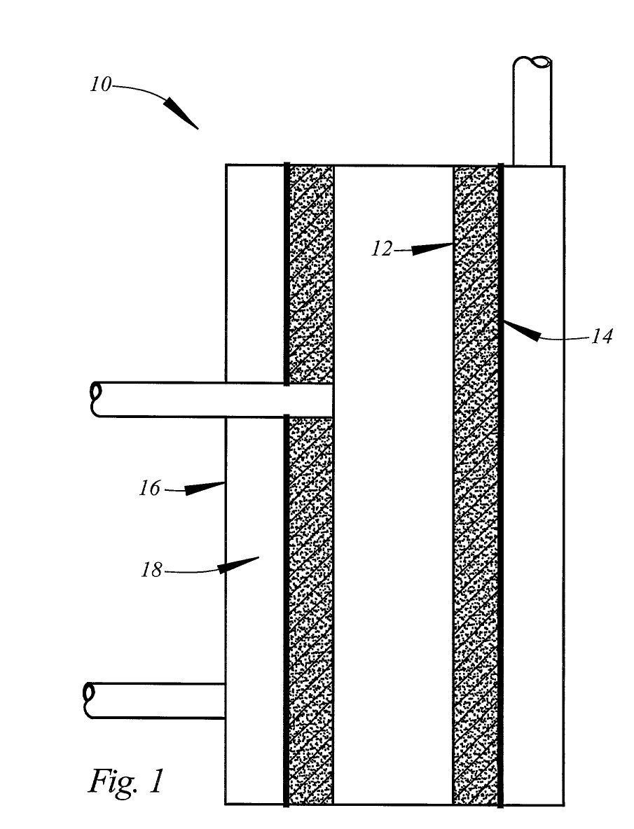

Referring now to the Drawings, and particularly to FIG. 1 thereof, there is shown a method of and apparatus for manufacturing methanol from methane 10 of the type disclosed and claimed in co-pending prior application Ser. No. 09/522,982, filed Mar. 10, 2000. In accordance with the method and apparatus 10, there is provided a porous partition 12 in the form of a hollow tube. The porous partition 12 comprises an inner container which receives methane in the hollow interior thereof. The porous partition 12 may have a photocatalytic layer 14 on the exterior surface thereof. Alternatively, the porous partition and the photocatalytic layer may be integrally formed.

An exterior tube 16 formed from a material that is transparent to radiation extends concentrically with the porous partition 12 to define an annulus 18 therebetween. The exterior tube 16 comprises a container which contains and directs a liquid, typically water, which flows longitudinally through the annulus 18. The methane within the hollow interior of the porous partition 12 is maintained at a pressure which causes the methane to flow through the porous partition 12 while preventing the flow of liquid into the interior thereof.

The porous partition 12 comprises pores or interstices of extremely small size. The small size of the pores or interstices of the porous partition 12 forms the methane flowing therethrough into sub-micron size bubbles. High relative velocity is maintained between the liquid flowing in the annulus 18 and the exterior surface of the porous partition 12 within shears the methane bubbles while they are still extremely small, thereby providing an extremely large surface area resulting in increased reaction efficiency. Electromagnetic radiation passing through the tube 16 engages the photocatalytic material 14 to form hydroxyl radicals in the flowing liquid. The hydroxyl radicals combine with the methane to form methanol.

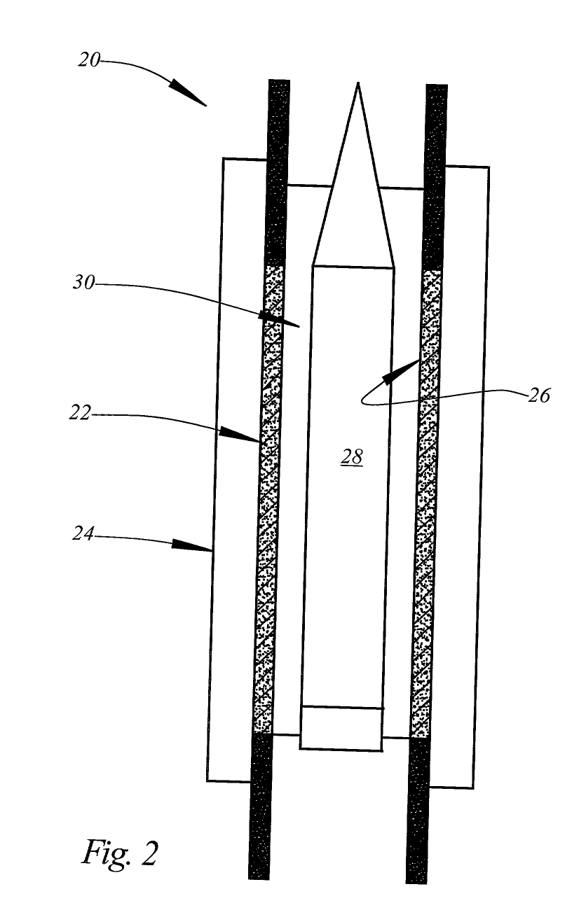

Referring now to FIG. 2 thereof, there is shown a method of and apparatus for manufacturing methanol from methane 20 of the type disclosed and claimed in co-pending prior application Ser. No. 09/522,982, filed Mar. 10, 2000. In accordance with the method and apparatus 20, there is provided a porous partition 22 in the form of a hollow tube. A gas impervious housing 24 surrounds the porous partition 22. The porous partition 22 may have a photocatalytic layer 26 on the interior surface thereof. Alternatively, the porous partition and the photocatalytic layer may be integrally formed.

A lamp 28 extends concentrically with the porous partition 22 to define an annulus 30 therebetween. The tube 22 comprises a container which contains and directs a liquid, typically water, which flows longitudinally through the annulus 30. Methane is maintained within the housing 24 at a pressure which causes the methane to flow through the porous partition 22 while preventing the flow of liquid into the interior thereof.

The porous partition 22 comprises pores or interstices of extremely small size. The small size of the pores or interstices of the porous partition 22 forms the methane flowing therethrough into sub-micron size bubbles. High relative velocity is maintained between the liquid flowing in the annulus 30 and the interior surface of the porous partition 22 which shears the methane bubbles while they are still extremely small, thereby providing an extremely large surface area resulting in increased reaction efficiency. Electromagnetic radiation from the lamp 28 engages the photocatalytic material to form hydroxyl radicals in the flowing liquid. The hydroxyl radicals combine with the methane to form methanol.

Those skilled in the art will appreciate the fact that the foregoing descriptions of the method of and apparatus for manufacturing methanol from methane 10 shown in FIG. 1 and of the method of and apparatus for manufacturing methanol from methane 20 shown in FIG. 2 comprise abbreviated descriptions thereof which are primarily intended to demonstrate the usefulness of the present invention. A more detailed understanding of the method of and apparatus for manufacturing methanol from methane 10 shown in FIG. 1 and of the method of and apparatus for manufacturing methanol from methane 20 shown in FIG. 2 may be had by reference to the full and complete descriptions thereof which comprise co-pending parent application Ser. No. 09/522,982, filed Mar. 10, 2000.

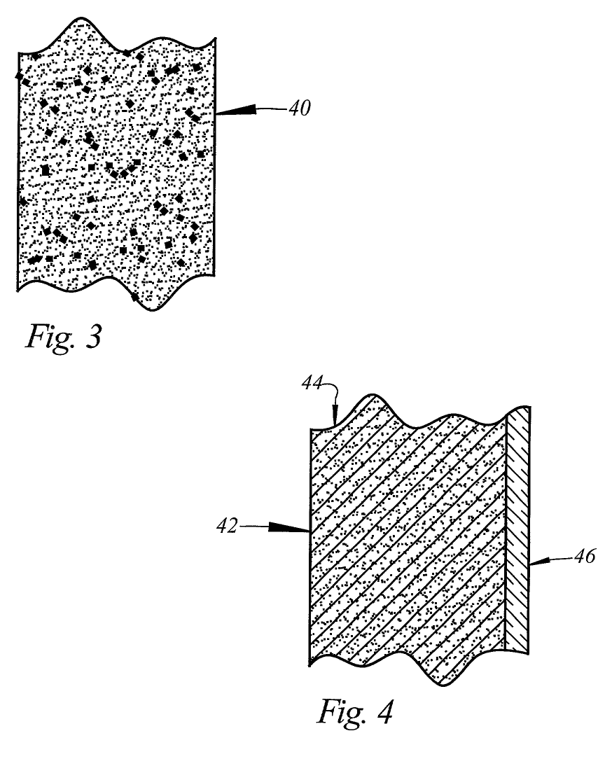

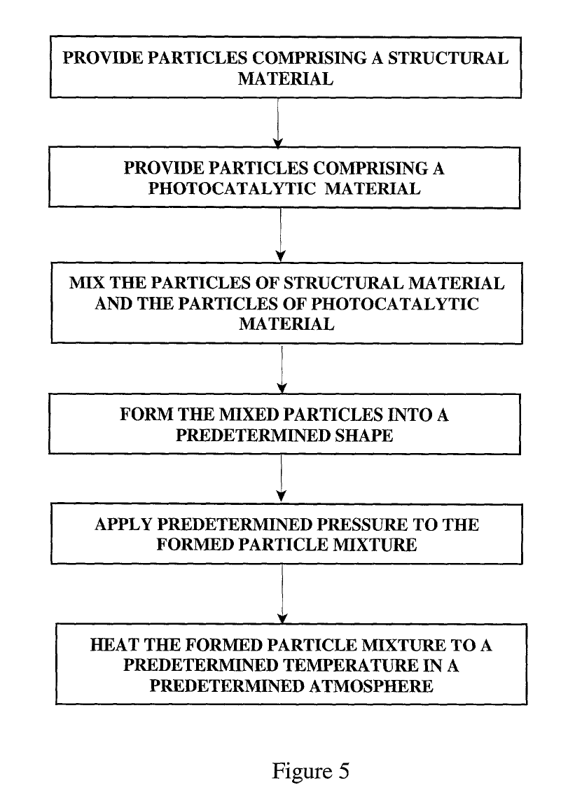

Referring now to FIG. 3, there is shown an integrally formed porous partition/photocatalytic article 40 comprising a first embodiment of the present invention. FIG. 5 comprises a flow chart illustrating the construction of the integrally formed porous partition/photocatalytic article 40.

In accordance with the first embodiment of the invention, particles comprising a selected photocatalytic material are mixed with particles comprising a selected structural material in accordance with a predetermined ratio. The particles of photocatalytic material preferably comprise a semi-conductor photocatalytic material, for example, a titanium-based photocatalytic material, a tungsten-based photocatalytic material, etc. The particles comprising the predetermined structural material may be formed from stainless steel, other metals, various ceramics, glass, and combinations thereof.

The mixture comprising the particles of structural material and the particles of photocatalytic material is formed into a predetermined configuration using any of various well known forming techniques such as molding. The formed article is then subjected to hydrostatic pressure. The application of hydrostatic pressure to the formed article determines the final configuration of the article and provides sufficient structural rigidity to facilitate further handling. Thereafter the formed article is heated to a predetermined temperature in a predetermined atmosphere. For example, the formed article may be heated to about 900° C. in a hydrogen atmosphere. The result is a sintered article 40 having predetermined porosity characteristics and predetermined photocatalytic characteristics.

The sintered article 40 is characterized by pores or interstices having diameters of between about 0.1 micron and about 1 micron. In the case of round or near-round pores or interstices, the term “diameter” is used in its usual sense. In the case of substantially non-round pores or interstices, the term “diameter” means the major dimension thereof.

Integrally formed porous partitions/photocatalytic articles constructed in accordance with the first embodiment of the invention are useful in the practice of the method of and apparatus for manufacturing methanol from methane disclosed and claimed in co-pending parent application Ser. No. 09/522,982, filed Mar. 10, 2000. For example, an integrally formed porous partition/photocatalytic article having a tubular configuration may be utilized in the method of and apparatus for manufacturing methanol from methane 10 illustrated in FIG. 1 in lieu of the porous partition 12 and the photocatalytic layer 14 formed thereon. Similarly, an integrally formed porous partition/photocatalytic article in the form of a tube may be utilized in the method of and apparatus for manufacturing methanol from methane 20 illustrated in FIG. 2 in lieu of the porous partition 22 and the photocatalytic layer 24 formed thereon. Other applications of the first embodiment of the present invention will readily suggest themselves of those skilled in the art.

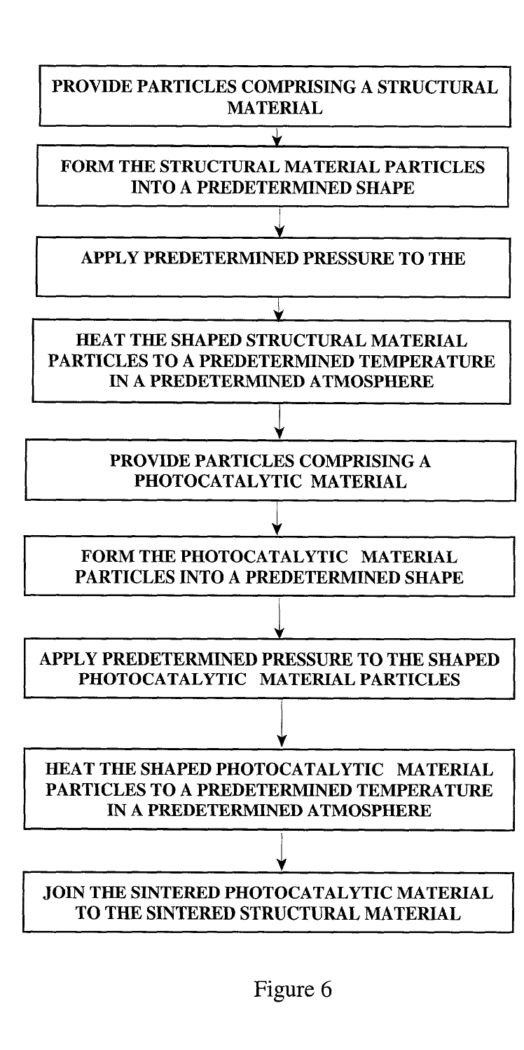

Referring now to FIG. 4, there is shown an integrally formed porous partition/photocatalytic article 42 comprising a second embodiment of the present invention. FIG. 6 comprises a flow chart illustrating the construction of the integrally formed porous partition/photocatalytic article 42.

In accordance with the second embodiment of the invention, particles comprising a selected structural material are formed into a predetermined configuration using any of various well known forming techniques, such as molding. The formed article is then subjected to hydrostatic pressure. The application of hydrostatic pressure to the formed article determines the final configuration of the article and provides sufficient structural rigidity to facilitate further handling. Thereafter the formed article is heated to a predetermined temperature in a predetermined atmosphere. For example, the formed article may be heated to about 900° C. in a hydrogen atmosphere. The result is a sintered article having predetermined porosity characteristics.

Further in accordance with the second embodiment of the invention, particles comprising a selected photocatalytic material are formed into a predetermined configuration utilizing any of various well known forming techniques, such as molding. The formed article is then subjected to hydrostatic pressure. The application of hydrostatic pressure to the formed article determines the final configuration of the article and provides sufficient structural rigidity to facilitate further handling. Thereafter the formed article is heated to a predetermined temperature in a predetermined atmosphere. For example, the formed article may be heated to about 900° C. in a hydrogen atmosphere. The result is a sintered article having predetermined photocatalytic characteristics.

Referring to FIG. 4, the article 42 comprises a sintered member 44 formed from particles of structural material and a sintered member 46 formed from particles comprising a photocatalytic material. The members 44 and 46 are joined one to another to form the article 42. Preferably, the articles 44 and 46 are provided with mating surfaces which facilitate the bonding of the member 46 to the member 44 to form the article 42.

The sintered member 44 of the article 42 is characterized by pores or interstices having diameters of between about 1 micron and about 5 microns. In the case of round or near-round pores or interstices, the term “diameter” is used in its usual sense. In the case of substantially non-round pores or interstices, the term “diameter” means the major dimension thereof.

The sintered member 46 has a thickness of between about 2 microns and about 100 microns. The sintered member 46 is further characterized by regularly spaced pores or interstices extending entirely through the catalyst layer and having diameters of between about 0.1 micron and about 1 micron.

Integrally formed porous partitions/photocatalytic articles constructed in accordance with the second embodiment of the invention are useful in the practice of the method of and apparatus for manufacturing methanol from methane disclosed and claimed in co-pending parent application Ser. No. 09/522,982, filed Mar. 10, 2000. For example, an integrally formed porous partition/photocatalytic article having a tubular configuration may be utilized in the method of and apparatus for manufacturing methanol from methane 10 illustrated in FIG. 1 in lieu of the porous partition 12 and the photocatalytic layer 14 formed thereon. Similarly, an integrally formed porous partition/photocatalytic article in the form of a tube may be utilized in the method of and apparatus for manufacturing methanol from methane 20 illustrated in FIG. 2 in lieu of the porous partition 22 and the photocatalytic layer 24 formed thereon. Other applications of the second embodiment of the present invention will readily suggest themselves of those skilled in the art.

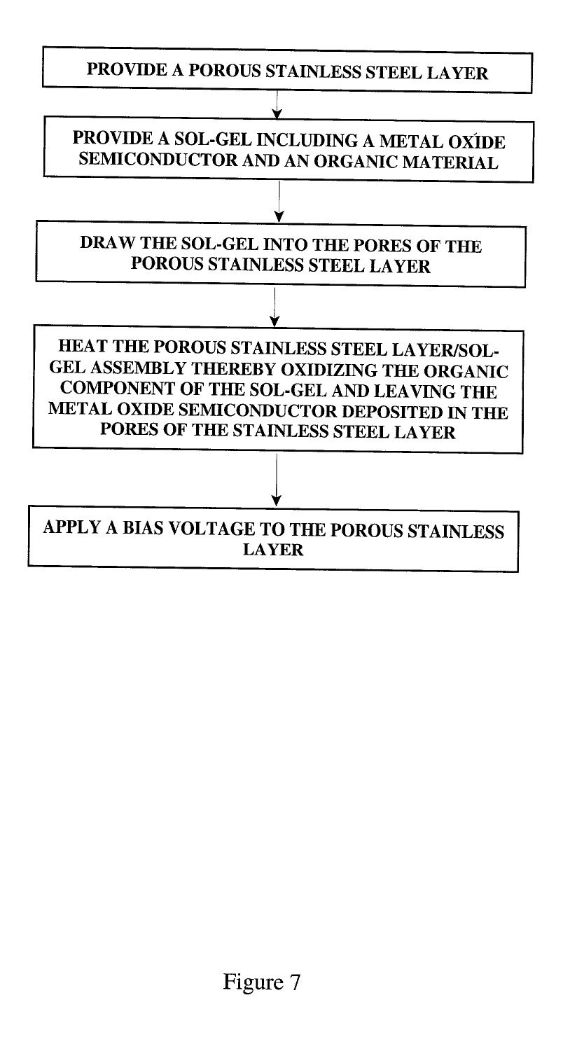

FIG. 7 illustrates a third embodiment of the invention. In accordance with the third embodiment, there is provided a porous stainless steel layer characterized by a predetermined nominal pore size. For example, the nominal pore size of the porous stainless steel layer may be between about 0.1 micron and about 1 micron. The porous stainless steel layer may comprise a sintered stainless steel layer. Other conventional manufacturing techniques may also be employed in the manufacture of the porous stainless steel layer.

One surface of the porous stainless steel layer is contacted with a sol-gel matrix. The sol-gel matrix is a mixture of a predetermined metal oxide semiconductor, usually in an alkoxide form and an organic component which serves as a template for assembly of the metal oxide semiconductor. For example, the metal oxide semiconductor may comprise a titanium-based photocatalytic material such as titanium dioxide, a tungsten-based photocatalytic material such as tungsten oxide, as well as other metal oxide semiconductors. The organic material may comprise, for example, ethoxysilane derivatives, or other amphilphilic block copolymers.

The sol-gel is drawn into the pores of the stainless steel layer. For example, the sol-gel may be drawn into the pores of the stainless steel layer by applying a vacuum to the opposite side of the stainless steel layer from the surface having the sol-gel applied thereto. Capillary action may also be used to the draw the sol-gel into the pores of the porous stainless steel layer.

After the sol-gel has been drawn into the pores of the porous stainless steel layer, the porous stainless steel layer/sol-gel assembly is placed in an oven and heated sufficiently to completely oxidize the organic components of the sol-gel. Depending upon the characteristics of the organic portion of the sol-gel, the pore size of the semiconductor oxide material deposited in the pores of the porous single layer can be precisely controlled. Preferably, both the pore size and the wall thickness of the semiconductor material deposited within the pores of the porous stainless steel layer are between about 10 and about 20 nanometers. Such dimensions causes holes in the valance band of the semiconductor material to reach the surface of the semiconductor material substantially immediately whereupon the holes are available for participation in an oxidation reaction, i.e., the conversion of methane to methanol.

Meanwhile, a suitable electrical field is applied to the porous stainless steel layer. This causes electrons from the semiconductor material to move into and through the porous stainless steel layer and to drain to an anode, thereby completing the oxidation/reduction couple.

It will therefore be understood that by applying a small bias voltage to the porous stainless steel layer the efficiency of the removal of the conduction band electrode from the semiconductor material is substantially enhanced. In this manner the possibility of an electron from the conduction band recombining with a hole from the valance band of the semiconductor material is substantially eliminated. This in turn means that the efficiency of the methane to methanol reaction is substantially increased.

Although preferred embodiments of the invention have been illustrated in the accompanying Drawing and described in the foregoing Detailed Description, it will be understood that the invention is not limited to the embodiments disclosed but is capable of numerous rearrangements, modifications, and substitutions of parts and elements without departing from the spirit of the invention.

1. A method of fabricating porous partition/photocatalytic articles including the steps of:
providing particles comprising a structural material;
providing particles comprising a photocatalytic material;
mixing the particles of structural material and the particles of photocatalytic material;
forming the mixed particles into a predetermined shape;
applying predetermined pressure to the formed particle mixture; and
heating the formed particle mixture to a predetermined temperature in a predetermined atmosphere.

2. A method of fabricating porous partition/photocatalytic articles including the steps of:
providing particles comprising a structural material;
forming the structural material particles into a predetermined shape;
applying predetermined pressure to the shaped structural material particles;
heating the shaped structural material particles to a predetermined temperature in a predetermined atmosphere;
providing particles comprising a photocatalytic material;
forming the photocatalytic material particles into a predetermined shape;
applying predetermined pressure to the shaped photocatalytic material particles;
heating the shaped photocatalytic material particles to a predetermined temperature in a predetermined atmosphere; and
joining the sintered photocatalytic material to the sintered structural material.

3. A method of fabricating porous partition/photocatalytic articles including the steps of:
providing a porous stainless steel layer;
mixing a predetermined metal oxide semiconductor with a predetermined organic material to form a sol-gel;
applying the resulting sol-gel to one surface of the porous stainless steel layer;
drawing the sol-gel into the pores of the porous stainless steel layer;
heating the resulting porous stainless steel layer/sol-gel assembly to oxidize the organic component of the sol-gel thereby leaving the metal oxide semiconductor component of the sol-gel in the pores of the porous stainless steel layer; and
applying a bias voltage to the porous stainless steel layer.
